(19) United States
(12) Patent Application Publication
(10) Pub. No.: US 2025/0156363 A1
(43) Pub. Date: May 15, 2025

(54) MEMORY DRIVE DEVICE, OPTICAL TRANSMISSION SYSTEM, AND MEMORY DRIVE METHOD

(71) Applicant: Fujitsu Limited, Kawasaki-shi (JP)

(72) Inventors: Ichiro YOKOKURA, Kawasaki-shi (JP); Junichi SUGIYAMA, Kawasaki-shi (JP); Yusuke TANABE, Kawasaki-shi (JP)

(73) Assignee: Fujitsu Limited, Kawasaki-shi (JP)

(21) Appl. No.: 18/913,275

(22) Filed: Oct. 11, 2024

(30) Foreign Application Priority Data
Nov. 13, 2023 (JP) 2023-192880

(51) Int. Cl. G06F 13/42; G06F 3/06; H04L 67/1097

(52) U.S. Cl. CPC G06F 13/4221; G06F 3/0604; G06F 3/0655; G06F 3/0679; H04L 67/1097; G06F 2213/0026

(57) ABSTRACT

A memory drive device includes a memory, and a processor coupled to the memory and configured to when receiving a specific packet according to a connection standard specified in Computer eXpress Link (CXL), store data included as a part of the specific packet in a buffer and determine whether addresses included as the part of the specific packet together with the data are consecutive, when the addresses are consecutive, generate first information in which information of the addresses that are consecutive and information of the data associated with the addresses that are consecutive are aggregated, and notify a memory device of a write request of the data to the memory device, based on the first information and the communication standard when the data stored in the buffer is written to the memory device specified by a communication standard that does not support the CXL.

### CROSS-REFERENCE TO RELATED APPLICATION

This application is based upon and claims the benefit of priority of the prior Japanese Patent Application No. 2023-192880, filed on Nov. 13, 2023, the entire contents of which are incorporated herein by reference.

### FIELD

A certain aspect of embodiments described herein relates to a memory drive device, an optical transmission system, and a memory drive method.

### BACKGROUND

An interconnect standard called Compute eXpress Link (CXL) is known as disclosed in, for example, Japanese Patent Application Laid-Open No. 2021-087216, U.S. Patent Application Publication No. 2020/0379930, and U.S. Pat. Nos. 11,375,050 and 11,601,377 (Patent Documents 1 to 4). The CXL uses the specifications of Peripheral Component Interconnect Express (PCIe), which is the mainstream of interconnect standards, to optimize the computing resources. Interconnect standards are sometimes referred to as interconnect protocols.

### SUMMARY

According to an aspect of the embodiments, there is provided a memory drive device including: a memory; and a processor coupled to the memory and configured to: when receiving a specific packet according to a connection standard specified in Computer eXpress Link (CXL), store data included as a part of the specific packet in a buffer and determine whether addresses included as the part of the specific packet together with the data are consecutive, when the addresses are consecutive, generate first information in which information of the addresses that are consecutive and information of the data associated with the addresses that are consecutive are aggregated, and notify a memory device of a write request of the data to the memory device, based on the first information and the communication standard when the data stored in the buffer is written to the memory device specified by a communication standard that does not support the CXL.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical transmission system.

FIG. 2 is a diagram for describing an example of direct accommodation.

FIG. 3A is a block diagram illustrating an example of a hardware configuration of an optical transmission device, and FIG. 3B is a block diagram illustrating an example of a functional configuration of the optical transmission device.

FIG. 4A is a block diagram illustrating an example of a functional configuration of a signal processing unit.

FIG. 4B is a block diagram illustrating another example of the functional configuration of the signal processing unit.

FIG. 5 illustrates an example of a format of a message area in a CXL packet.

FIG. 6 is a diagram for describing an example of the process executed by a framer unit.

FIG. 7 is a diagram for describing an example of generation of message information and an example of entry to a first queue.

FIG. 8 is a diagram for describing an example of transfer of the message information and an example of entry of completion notification information into a second queue.

FIG. 9 is a flowchart illustrating an example of the operation of the optical transmission device at the time of transmission.

FIG. 10 is a flowchart illustrating an example of the operation of the optical transmission device at the time of reception.

### DESCRIPTION OF EMBODIMENTS

In some cases, a plurality of servers are installed in one data center, and data communication is performed between the servers. Further, data communication may be performed between servers installed in different data centers. When data communication is performed between servers, processors of the servers are used for the data communication. When application software of a server is executed while the processor is used for data communication, for example, the load on the processor increases.

To reduce such an increase in the load on the processor, a smart network interface card (NIC) has been attracting attention. The smart NIC includes a processor, and is used by being attached to, for example, a PCIe slot of the server. The smart NIC extracts a transaction layer packet called a PCIeTLP (PCIe transaction layer packet) from a PCIe frame (or a PCIe physical packet) received as a client signal from the server. When the packet is extracted, the smart NIC accommodates the extracted packet in an Ethernet (registered trademark) frame and transmits it. Since the smart NIC shares the processing related to data communication separately from the server, an increase in the load on the processor of the server is reduced.

Further, in order to achieve low latency and low power consumption in data communication, it is assumed that an optical transmission function is installed to the smart NIC. In this case, the smart NIC having the optical transmission function (hereinafter, referred to as an optical transmission device) accommodates an Ethernet (registered trademark) frame in an optical transport network (OTN) frame and transmits the OTN frame to an optical transmission network. The optical transmission network is often provided between two different stations that are far apart from each other, for example, by several tens to several hundreds of kilometers. The optical transmission device can perform such far-distance (or long-distance) optical transmission using a transmission frame for optical transmission such as an OTN frame.

However, due to the appearance of the CXL described above, a client signal in which a CXL packet is stored may be input to the optical transmission device. The CXL packet corresponds to, for example, MemWr of M2S RwD (Master to Subordinate Request with Data). The CXL packet includes a transaction layer packet according to a protocol called CXL.mem as CXL information.

When the client signal includes a CXL packet, the optical transmission device extracts the CXL packet from the client signal, accommodates the CXL packet in a transmission frame, and transmits the transmission frame from a transmission source station to a transmission destination station. However, if a memory device with a communication standard that can support the CXL is not disposed in the transmission destination station, the optical transmission device cannot access the memory device and cannot write CXL information included in the CXL packet in the memory device. Even if the memory device is disposed in the transmission source station, the optical transmission device cannot access the memory device.

For example, when the CXL is supported by the communication standard of the memory device, the optical transmission device can access the memory device and write the CXL information in the memory device. However, in this case, the communication speed between the optical transmission device and the memory device is limited to a communication speed according to the communication standard of the memory device, and thus there is a concern that high-speed memory access cannot be achieved.

Hereinafter, embodiments for carrying out the present disclosure will be described with reference to the drawings.

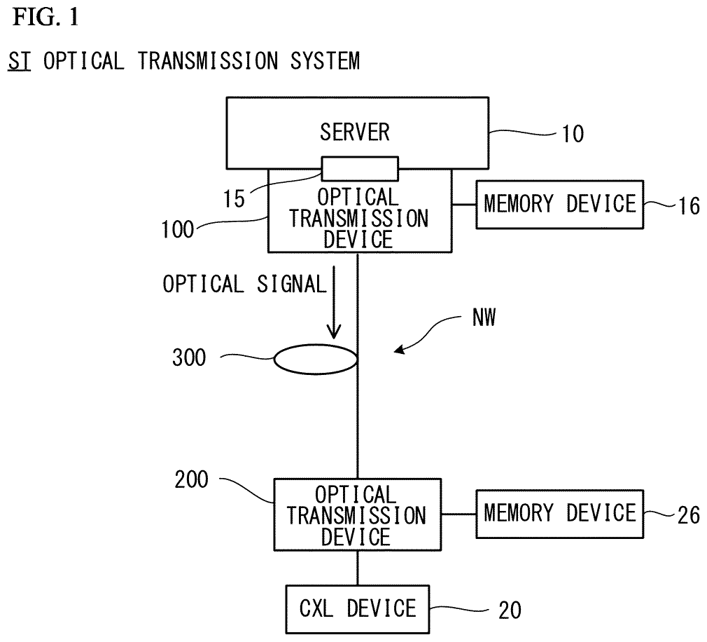

As illustrated in FIG. 1, an optical transmission system ST includes optical transmission devices 100 and 200. The optical transmission devices 100 and 200 are connected to each other over an optical transmission network NW. The optical transmission network NW includes an optical transmission line 300. The optical transmission line 300 includes, for example, an optical fiber, an optical amplifier, and the like.

The optical transmission device 100 is connected to a server 10 via a PCIe connection unit 15. The PCIe connection unit 15 includes a PCIe slot of the server 10 and a connector of the optical transmission device 100. The optical transmission device 100 is connected to the server 10 by attaching the connector to the PCIe slot. The optical transmission device 100 is electrically connected to a memory device 16. The memory device 16 is an external storage device (that is, an extended storage device) that supports a communication standard called non-volatile memory express (NVMe). The storage device includes a solid state drive (SSD), a nonvolatile memory, and the like.

The optical transmission device 200 is electrically connected to a CXL device 20. The CXL device 20 is an external storage device (i.e., an extended storage device) that supports a connection standard called CXL. The storage device includes an SSD, a nonvolatile memory, and the like. The optical transmission device 200 is electrically connected to a memory device 26. The memory device 26 is basically the same as the memory device 16, and therefore, detailed description thereof will be omitted.

The optical transmission device 100 receives a client signal, which is an electrical digital signal, from the server 10. The optical transmission device 100 converts the received client signal into a transmission frame for optical transmission.

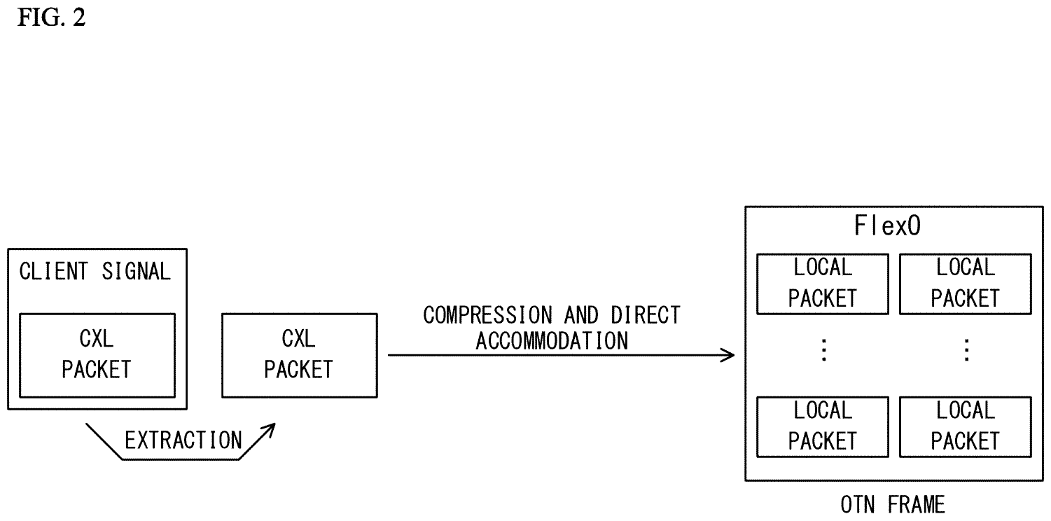

For example, as illustrated in FIG. 2, an electrical client signal in which a CXL packet is stored may be input to the optical transmission device 100. The CXL packet is an example of a specific packet and corresponds to MemWr of M2S RwD. Although the details will be described later, the CXL packet includes a transaction layer packet according to a protocol called CXL.mem as CXL information. The transaction layer is different from the physical layer.

The optical transmission device 100 extracts a CXL packet from the input client signal. Here, the CXL as a connection standard cannot support the NVMe as a communication standard due to the compatibility of the standard. The NVMe as a communication standard can support the PCIe as a connection standard due to the compatibility of the standard. That is, the NVMe can perform communication over the PCIe but cannot perform communication over the CXL.

After extracting the CXL packet, the optical transmission device 100 compresses the CXL packet and directly accommodates the compressed new CXL packet as a local packet in an OTN frame, which is an electrical digital signal. Such direct accommodation may be referred to as direct mapping. When there is a margin in the OTN frame, the optical transmission device 100 sequentially accommodates some or all of the subsequent local packets in the OTN frame. Thus, the OTN frame accommodates a plurality of compressed CXL packets as local packets.

Referring back to FIG. 1, when the optical transmission device 100 accommodates a plurality of local packets that are a plurality of compressed CXL packets in the OTN frame, the optical transmission device 100 generates a forward error correction (FEC), which is an error correction code, and adds the FEC to the OTN frame. After adding the FEC to the OTN frame, the optical transmission device 100 converts the OTN frame into an optical signal and transmits the optical signal to the optical transmission line 300. In the above described manner, the optical transmission device 100 transmits an optical signal to the optical transmission device 200.

The optical transmission device 200 receives an optical signal from the optical transmission line 300. That is, the optical transmission device 200 receives an optical signal that has been transmitted from the optical transmission device 100 and passed through the optical transmission line 300. When receiving the optical signal, the optical transmission device 200 converts the optical signal into an OTN frame, extracts the FEC from the OTN frame, and performs error correction. After error correction, the optical transmission device 200 extracts (de-maps) the local packets from the OTN frame, restores the CXL packets from the local packets, and transfers the CXL packets to the CXL device 20.

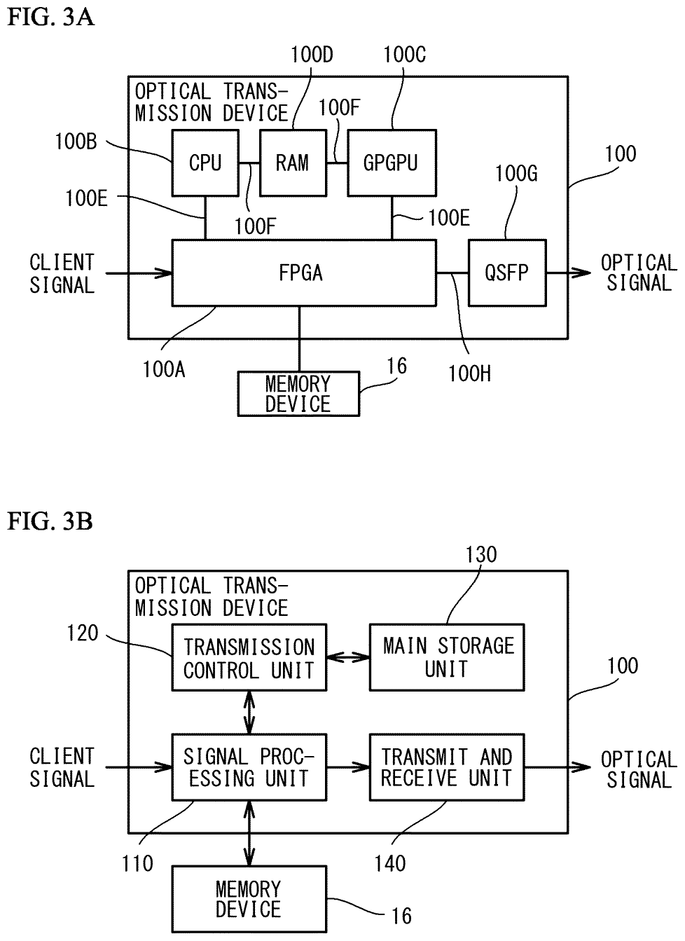

The configuration of the optical transmission device 100 will be described in detail with reference to FIG. 3. The optical transmission device 200 has basically the same configuration as the optical transmission device 100, and thus detailed description thereof will be omitted.

First, as illustrated in FIG. 3A, the optical transmission device 100 includes a field programmable gate array (FPGA) 100A, a central processing unit (CPU) 100B, and a general purpose computing with graphic processing unit (GPGPU) 100C. Each of the FPGA 100A, the CPU 100B, and the GPGPU 100C is a hardware circuit including a processor. The optical transmission device 100 includes a random access memory (RAM) 100D as a hardware circuit and a quad small form factor pluggable (QSFP) 100G as an optical transceiver. For example, a double-data-rate synchronous dynamic random access memory (DDR SDRAM) is adopted as the RAM.

The FPGA 100A processes an optical transmission layer, and the GPGPU 100C processes an Internet protocol (IP) layer. The CPU 100B controls the entire processing of the optical transmission device 100 including the digital signal processing. Instead of the FPGA 100A, a hardware circuit such as a digital signal processor (DSP), an application specific integrated circuit (ASIC), or a large-scale integration (LSI) may be employed.

The FPGA 100A is connected to the CPU 100B and the GPGPU 100C by an internal bus 100E. The CPU 100B and the GPGPU 100C are connected to the RAM 100D by an internal bus 100F. The FPGA 100A is connected to the QSFP 100G by an internal bus 100H. The QSFP 100G is disposed at a stage subsequent to the FPGA 100A. The FPGA 100A implements functions described later and executes various processes according to the flowchart described below. For example, the FPGA 100A implements various functions by a program stored in the FPGA 100A, and executes various processes. The memory device 16 is connected to the FPGA 100A.

As illustrated in FIG. 3B, the optical transmission device 100 includes a signal processing unit 110, a transmission control unit 120, a main storage unit 130, and a transmit and receive unit 140. The signal processing unit 110 can be implemented by the FPGA 100A described above. The transmission control unit 120 can be implemented by the CPU 100B and the GPGPU 100C described above. The main storage unit 130 can be implemented by the RAM 100D described above. The transmit and receive unit 140 can be implemented by the QSFP 100G described above. Therefore, the signal processing unit 110 is connected to the transmission control unit 120 and the transmit and receive unit 140, and the transmission control unit 120 is connected to the main storage unit 130. The memory device 16 is connected to the signal processing unit 110.

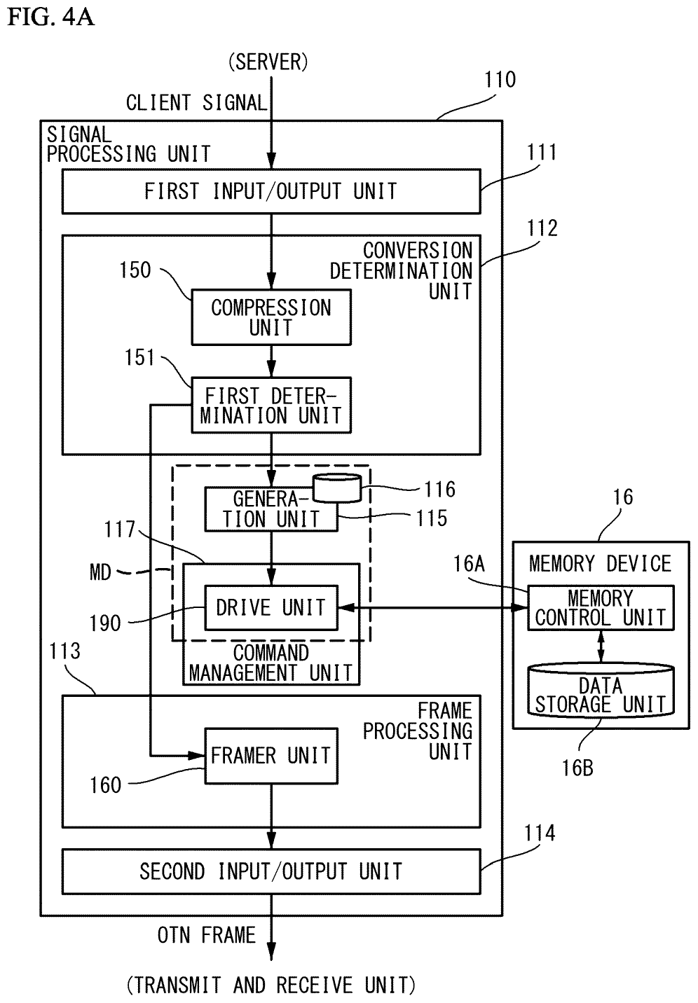

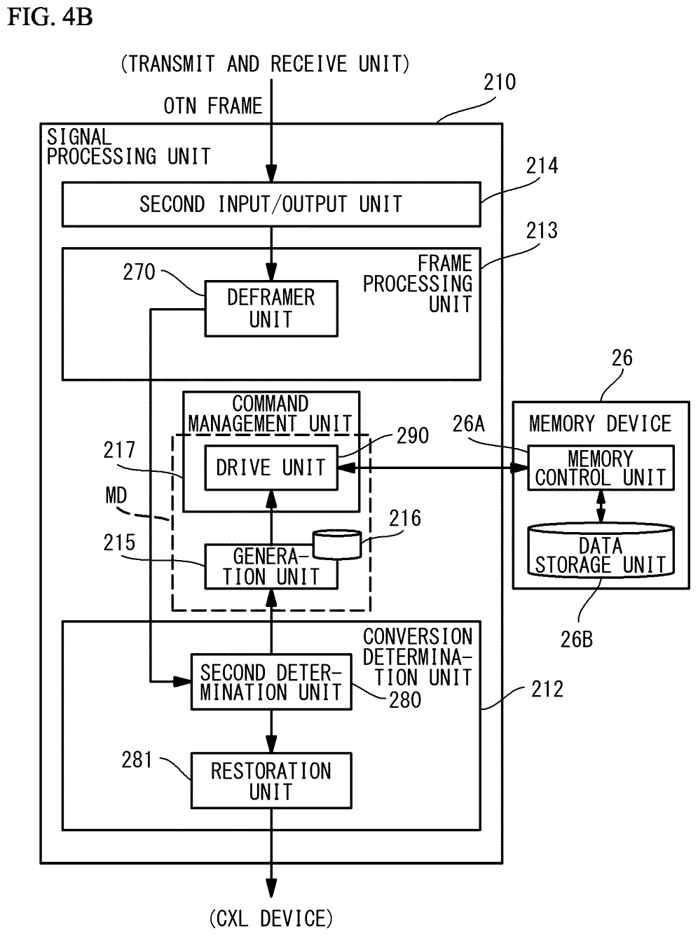

Referring to FIG. 4A to FIG. 8, details of the memory devices 16 and 26, the signal processing unit 110, and a signal processing unit 210 of the optical transmission device 200 are described.

As illustrated in FIG. 4A, the memory device 16 includes a memory control unit 16A and a data storage unit 16B. The signal processing unit 110 includes a first input/output unit 111, a conversion determination unit 112, a frame processing unit 113, and a second input/output unit 114. The signal processing unit 110 includes a generation unit 115, a data buffer 116, and a command management unit 117. The data buffer 116 is associated with the generation unit 115.

The conversion determination unit 112 includes a compressing unit 150 and a first determination unit 151. The frame processing unit 113 includes a framer unit 160. The command management unit 117 includes a drive unit 190. The drive unit 190 is an example of a notification unit. The command management unit 117 also includes two types of queues for storing information, which will be described in detail later. A memory drive device MD can be implemented by at least the generation unit 115 and the drive unit 190. The memory drive device MD may include the data buffer 116 and the above-described queue.

The client signals output from the server 10 are sequentially and continuously input to the first input/output unit 111. When the client signals are input to the first input/output unit 111, the first input/output unit 111 extracts the CXL packets accommodated in the respective client signals (see FIG. 2), and sequentially outputs the CXL packets to the compression unit 150.

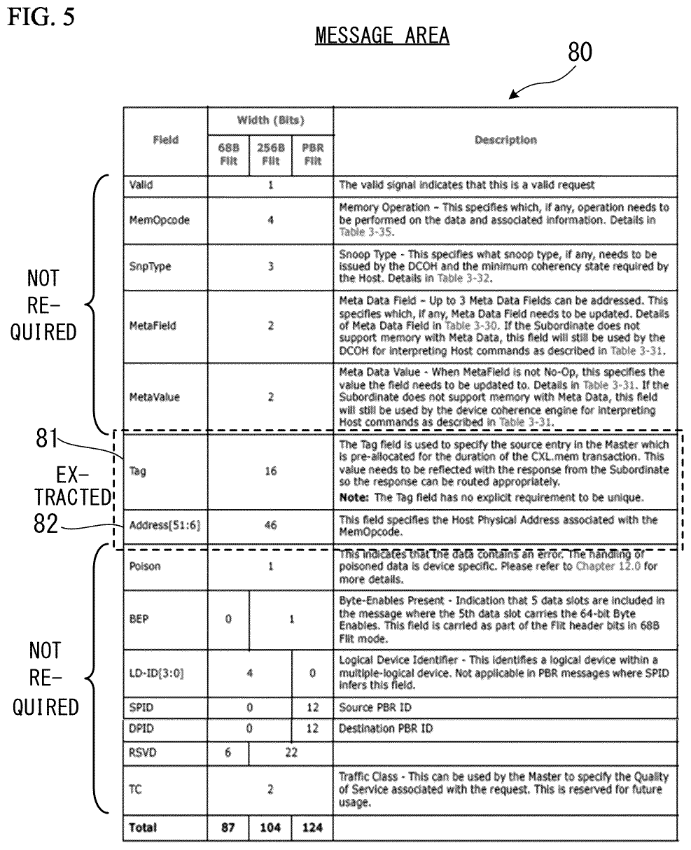

The compression unit 150 compresses the CXL packets. The compression unit 150 compresses the CXL packets to generate new local packets obtained by compressing the CXL packets. More specifically, as illustrated in FIG. 5, the compression unit 150 first extracts a part of the message data stored in a message area 80 of the CXL packet. For example, the compression unit 150 extracts 16-bit flag data stored in a tag area 81 in the message area 80. The flag data is an example of flag information. The compression unit 150 extracts 46-bit address data stored in an address area 82 in the message area 80.

When the flag data and the address data are extracted, the compression unit 150 generates a new local packet in which the extracted flag data, the extracted address data, and a predetermined delimiter expressed by 2 bits are set as new message data. The new message data is 64 bits (8 bytes). The predetermined delimiter is data for identifying the IDLE pattern. The local packet contains, together with the new message data, the write target data stored as the data body in the data area (or payload area) of the original CXL packet in its original state.

In this manner, the compression unit 150 compresses the original CXL packet by limiting the data to the flag data, the address data, the predetermined delimiter, and the write target data to generate a local packet. The compression of the original CXL packet into the local packet allows more write target data to be accommodated in a single OTN frame.

The first determination unit 151 determines whether to convert the processing format of the local packet from a first processing format that does not support the NVMe to a second processing format that supports the NVMe based on the local packet output from the compression unit 150.

For example, when the write target data of the local packet is written into the data storage unit 16B of the memory device 16, if the processing format is not converted, the write target data is not written into the data storage unit 16B. As described above, since the memory device 16 supports the NVMe as a communication standard, the memory device 16 cannot support a local packet obtained by compressing the CXL packet specified by the CXL as a connection standard.

On the other hand, when the write target data of the local packet is written in the data storage unit 26B (see FIG. 4B) of the memory device 26, the local packet is accommodated in the OTN frame and propagates through the optical transmission line 300 as an optical signal even if the processing format is not converted. In this case, since the memory device 26 connected to the optical transmission device 200 supports the NVMe as a communication standard, the memory device 26 cannot support the local packet obtained by compressing a CXL packet specified by the CXL as a connection standard.

Therefore, the first determination unit 151 determines whether to convert the processing format of the local packet from the first processing format that does not support the NVMe to the second processing format that supports the NVMe based on the flag data stored in the local packet. The flag data can be defined in advance with the CPU of the server 10, and the CPU of the server 10 may determine whether to store the flag data in the CXL packet.

Although details will be described later, there are two types of flag data, first flag data and second flag data. The first flag data is used to determine whether the optical transmission device 100 converts the processing format of the local packet from the first processing format to the second processing format. In other words, the first flag data is used to determine whether to accommodate the local packet in the OTN frame. The second flag data is used to determine whether the optical transmission device 200 converts the processing format of the local packet from the first processing format to the second processing format. In other words, the second flag data is used to determine whether to restore the local packet to the original CXL that is the CXL packet before being compressed.

When the processing format of the local packet is not converted from the first processing format to the second processing format, the first determination unit 151 outputs the local packet to the framer unit 160. When converting the processing format of the local packet from the first processing format to the second processing format, the first determination unit 151 outputs the local packet to the generation unit 115.

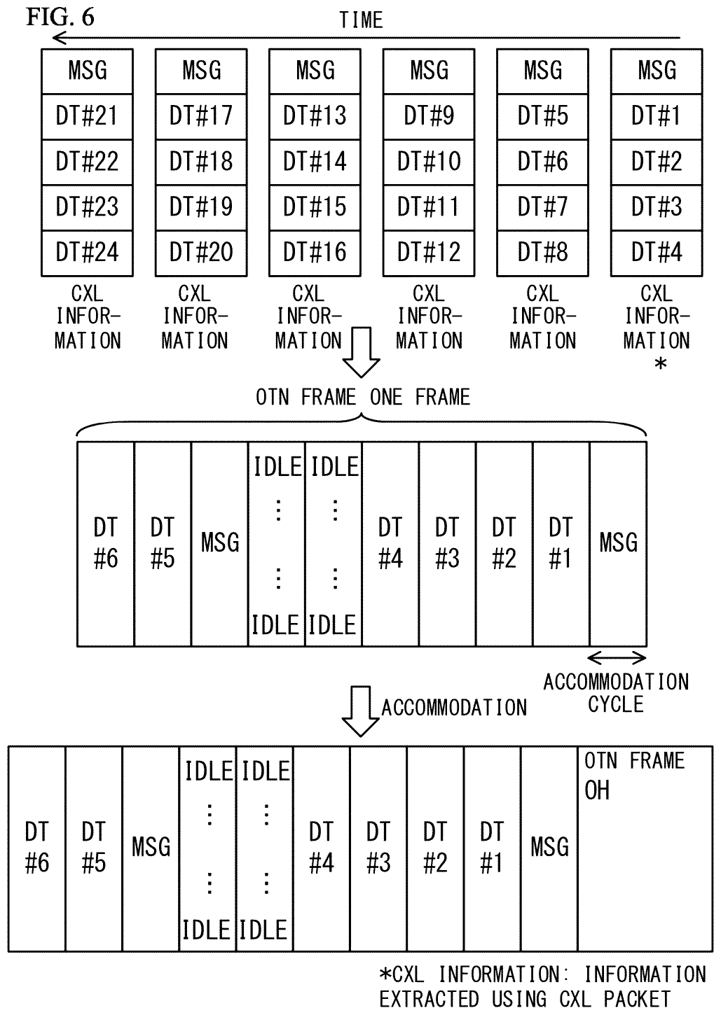

The framer unit 160 acquires the message data and the write target data for one accommodation cycle held as a data chunk by the local packet and accommodates the message data and the write target data in the OTN frame as CXL information. For example, as illustrated in FIG. 6, the framer unit 160 accommodates a data chunk for one accommodation period in a payload section located behind the overhead (denoted by OH in FIG. 6) of the OTN frame. That is, the framer unit 160 accommodates the message data and the write target data (denoted by DT in FIG. 6) in the payload section as CXL information.

When accommodating the data chunk in the OTN frame, the framer unit 160 outputs the OTN frame to the second input/output unit 114. The second input/output unit 114 transfers the OTN frame output from the framer unit 160 to the transmit and receive unit 140 (see FIG. 3B). The transmit and receive unit 140 converts the OTN frame into an optical signal and transmits the optical signal to the optical transmission device 200.

Although not illustrated, the transmit and receive unit 140 includes an FEC encoder that adds an FEC to the OTN frame, a digital analogue converter (DAC) that converts the OTN frame from a digital format to an analogue format, and the like. The transmit and receive unit 140 includes an optical modulator that converts an OTN frame in an analog format into an optical signal using local oscillator light and transmits the optical signal, and a coherent receiver that converts an optical signal received from an optical transmission line 310 into an OTN frame in an analog format using local oscillator light. In addition, the transmit and receive unit 140 includes an analogue digital converter (ADC) that converts an OTN frame in an analogue format into an OTN frame in a digital format, an FEC decoder that performs error correction of the OTN frame based on the FEC added to the OTN frame and outputs the OTN frame to the second input/output unit 114, and the like.

As illustrated in FIG. 4B, the memory device 26 includes a memory control unit 26A and a data storage unit 26B. The signal processing unit 210 includes a conversion determination unit 212, a frame processing unit 213, and a second input/output unit 214. The signal processing unit 210 includes a generation unit 215, a data buffer 216, and a command management unit 217. The data buffer 216 is associated with the generation unit 215.

The conversion determination unit 212 includes a second determination unit 280 and a restoration unit 281. The frame processing unit 213 includes a deframer unit 270. The command management unit 217 includes a drive unit 290. The drive unit 290 is an example of a notification unit. The command management unit 217 also includes two types of queues, as in the command management unit 117. The memory drive device MD can be implemented by at least the generation unit 215 and the drive unit 290. The memory drive device MD may include the data buffer 216 and the above-described queue.

When an OTN frame output from the transmit and receive unit (not illustrated) of the optical transmission device 200 is input to the second input/output unit 214, the second input/output unit 214 transfers the OTN frame to the deframer unit 270. The deframer unit 270 extracts the local packet from the OTN frame transferred from the second input/output unit 214 and outputs the local packet to the second determination unit 280. The local packet extracted from the OTN frame by the deframer unit 270 does not include a part of the message data excluded when the compression unit 150 performs compression. This is because the deframer unit 270 does not extract the CXL packet from the OTN frame. When the deframer unit 270 extracts the local packet, the deframer unit 270 outputs the local packet to the second determination unit 280.

The second determination unit 280 determines whether to convert the processing format of the local packet from the first processing format that does not support the NVMe to the second processing format that supports the NVMe based on the local packet output from the deframer unit 270. More specifically, the second determination unit 280 determines whether to convert the processing format of the local packet from the first processing format to the second processing format based on the second flag data stored in the local packet. When it is determined that the processing format of the local packet is not converted from the first processing format to the second processing format, the second determination unit 280 outputs the local packet to the restoration unit 281. When it is determined that the processing format of the local packet is converted from the first processing format to the second processing format, the second determination unit 280 outputs the local packet to the generation unit 215. The second determination unit 280 basically performs the same process as the first determination unit 151, and thus detailed description thereof will be omitted.

The restoration unit 281 restores the CXL packet from the local packet. For example, the restoration unit 281 restores the original CXL packet by adding restoration data of a fixed value (that is, 64 bits) corresponding to the number of bits of the message data excluded from the extraction target by the compression unit 150 to the local packet. When the restoration unit 281 restores the original CXL packet, the restoration unit 281 outputs this CXL packet to the CXL device 20. Thus, the CXL packet output from the restoration unit 281 is input to the CXL device 20.

As illustrated in FIG. 4A, the generation unit 115 receives the local packet output from the first determination unit 151. As illustrated in FIG. 4B, the generation unit 215 receives the local packet output from the second determination unit 280. The local packets received by the generation units 115 and 215 include message data and write target data. The message data includes flag data, address data, and a predetermined delimiter. When receiving the local packet, the generation unit 115 excludes the flag data and the delimiter, and stores entry information in which the address data and the write target data are associated with each other in the data buffer 116. This is to ensure efficient use of the queue described below when the drive unit 190 accesses the memory device 16. Similarly, when receiving the local packet, the generation unit 215 excludes the flag data and the delimiter and stores entry information in which the address data and the write target data are associated with each other in the data buffer 216. This is to ensure efficient use of the queue described below when the drive unit 290 accesses the memory device 26.

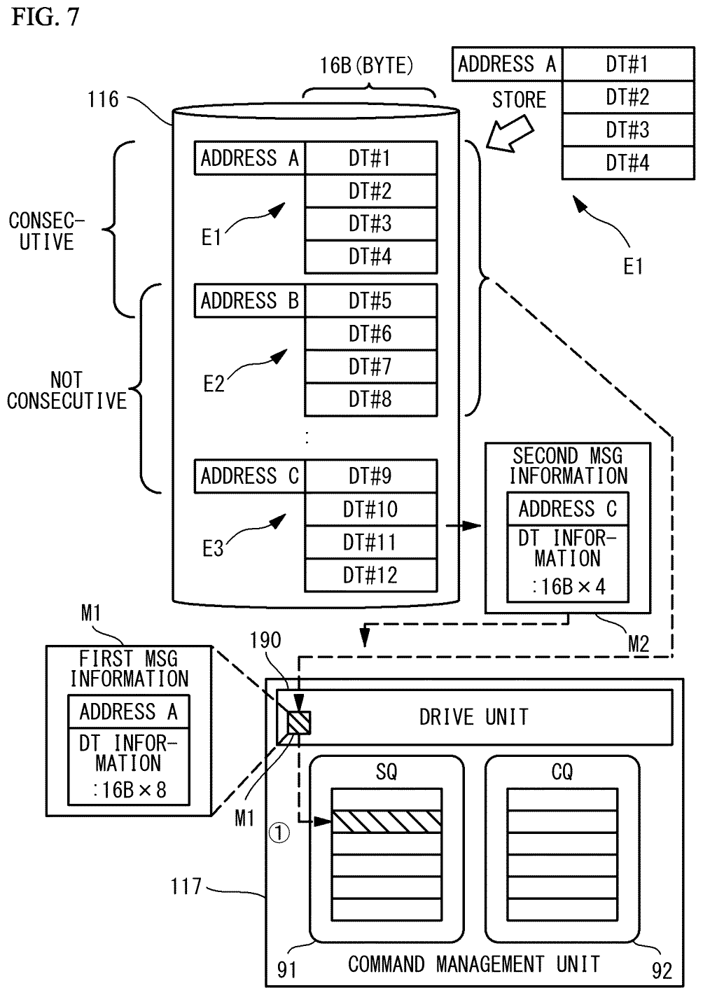

For example, when the generation unit 115 stores the entry information in the data buffer 116, the data buffer 116 stores entry information E1, E2, and E3 in which the address data and the write target data (indicated by DT in FIG. 7) are associated with each other, as illustrated in FIG. 7. Each of four pieces of write target data #1, #2, #3, and #4 associated with the address data “A” has a size of 16 bytes. Four pieces of write target data associated with each of the address data “B” and the address data “C” are also the same as the case of the address data “A”, and thus detailed description thereof will be omitted.

After storing the entry information E1, E2, and E3, the generation unit 115 checks the continuity of the address data contained in the entry information E1, E2, and E3. For example, the generation unit 115 checks whether the address data “A” and the address data “B” are consecutive, whether the address data “B” and the address data “C” are consecutive, and the like.

When the address data “A” and the address data “B” are consecutive, the generation unit 115 generates first message (MSG) information M1 in which the address data “A”, the four pieces of write target data #1, #2, #3, and #4 associated with the address data “A”, and the four pieces of write target data #5, #6, #7, and #8 associated with the address data “B” are aggregated. The first message information is an example of first information. The size of the first message information M1 is at least larger than 128 bytes, and is larger than the size of the 64-byte write target data (16 bytes×four pieces of write target data) included in the local packet alone.

On the other hand, when the address data “B” and the address data “C” are not consecutive, the generation unit 115 generates second message (MSG) information M2 in which four pieces of write target data #9, #10, #11, and #12 associated with the single address data “C” are aggregated. The second message information is an example of second information. When the address data “B” and the address data “C” are consecutive, the generation unit 115 may aggregate four pieces of write target data #9, #10, #11, and #12 into the first message information M1.

As described above, when the address data has continuity, the generation unit 115 can generate message information having a size larger than the size of the write target data included in the local packet alone. That is, when the address data has continuity, the generation unit 115 can generate message information having a size of at least 16 bytes×4×the number of pieces of entry information.

When the generation unit 115 generates the first message information M1, the second message information M2, or the like, the generation unit 115 outputs the first message information M1, the second message information M2, or the like to the drive unit 190 of the command management unit 117. Accordingly, the first message information M1, the second message information M2, and the like are input to the drive unit 190. For example, when the first message information M1 is input to the drive unit 190, the drive unit 190 enters (registers) the first message information M1 in a first queue 91 of the first queue 91 and a second queue 92 included in the command management unit 117.

The first queue 91 is a circular buffer used by the drive unit 190 to issue a write command to the memory control unit 16A. The write command is an example of a write request. The first queue 91 may be referred to as a submission queue (SQ). The drive unit 190 issues a write command for the write target data included in the first message information M1, based on the first message information M1 entered in the first queue 91.

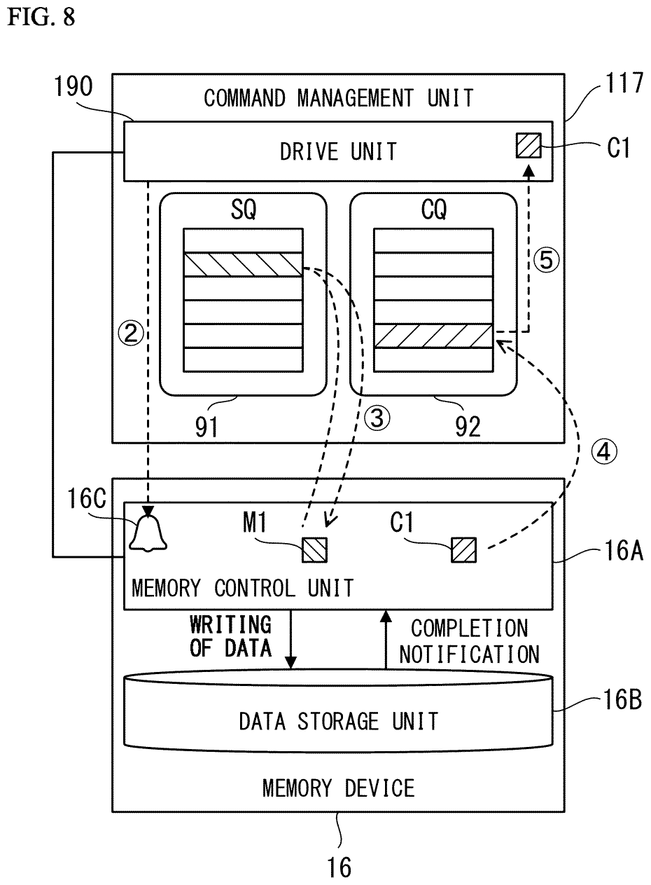

When the first message information M1 is entered into the first queue 91, as illustrated in FIG. 8, the drive unit 190 notifies a doorbell register 16C of the memory control unit 16A of the completion of the entry of the first message information M1 into the first queue 91 and a write command. Accordingly, the memory control unit 16A accesses the first queue 91 and reads the first message information M1 from the first queue 91. Then, the memory control unit 16A writes the write target data included in the first message information M1 into the data storage unit 16B.

When writing of the write target data to the data storage unit 16B is completed, the data storage unit 16B outputs a completion notification to the memory control unit 16A. In response to the completion notification, the memory control unit 16A generates completion notification information C1 indicating that the processing on the first message information M1 is completed, and enters the completion notification information C1 in the second queue 92. The second queue 92 is a circular buffer that stores the completion notification information C1 and the like. The second queue 92 may be referred to as a completion queue (CQ).

The drive unit 190 monitors the second queue 92, and acquires the completion notification information C1 when the completion notification information C1 is entered in the second queue 92. Although not illustrated, when the completion notification information C1 is acquired, the drive unit 190 transmits the completion notification information C1 to the CPU of the server 10. Thus, when the client signal including the CXL packet is output from the server 10, the CPU of the server 10 can confirm that the writing of the write target data included in the CXL packet of the client signal output from the server 10 is completed.

In this manner, some of data included in the local packet is aggregated into the first message information M1 that can support the NVMe. This allows the signal processing unit 110 to write the write target data in the memory device 16 using the PCIe as the connection standard and the NVMe as the communication standard without being limited to the CXL as the connection standard. The signal processing unit 110 may write the write target data alone or may write the write target data together with the address data.

When the address data are consecutive, multiple pieces of write target data associated with the consecutive address data are aggregated into the first message information M1 or the like. That is, the amount of write target data that can be transferred to the memory device 16 by one output increases. This can improve the communication speed of memory access to the memory device 16 by the signal processing unit 110.

For example, when the entry cycle to the first queue 91 is shorter than the processing time of the memory control unit 16A, the first queue 91 may be congested or overflow, and not accept entries. In this case, if the size of the entry information is 64 bytes, the communication speed after the entry is not accepted is limited to the processing time of the memory control unit 16A×64 bytes. However, in the present embodiment, the memory control unit 16A processes the write target data having a size larger than 64 bytes. Therefore, the memory control unit 16A has a margin for processing, and the signal processing unit 110 can improve the communication speed of memory access to the memory device 16. The signal processing unit 110 has been described above as an example with reference to FIG. 7 and FIG. 8, but the signal processing unit 210 is basically the same as the signal processing unit 110, and thus the detailed description of the signal processing unit 210 will be omitted.

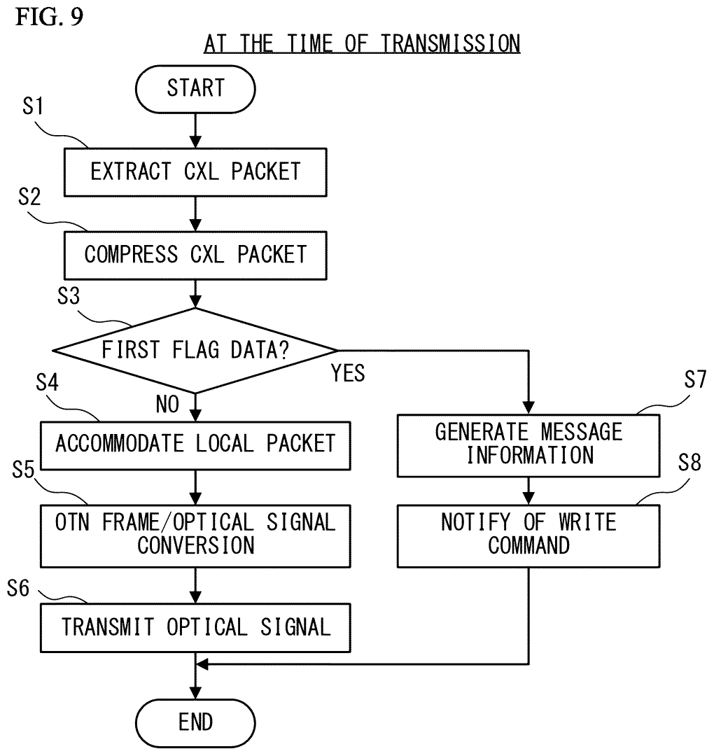

Next, the operation of the optical transmission device 100 at the time of transmission will be described with reference to FIG. 9.

First, the first input/output unit 111 extracts a CXL packet from a client signal (step S1). When the first input/output unit 111 extracts the CXL packet, the compression unit 150 compresses the CXL packet (step S2). As described above, the compression unit 150 extracts the flag data and the address data stored in the tag area 81 in the message area 80, and generates a new local packet in which the extracted flag data, the extracted address data, and the like are set as new message data.

When the compression unit 150 compresses the CXL packet to generate the local packet, the first determination unit 151 determines whether the flag data is first flag data (step S3). That is, the first determination unit 151 checks the message data of the local packet and determines whether the first flag data is included in the message data. For example, when the flag data is not the first flag data, for example, when the flag data is second flag data (step S3: NO), the framer unit 160 accommodates the local packet (step S4). That is, the framer unit 160 acquires the message data and the write target data for one accommodation cycle held as a data chunk by the local packet and accommodates the message data and the write target data in the OTN frame. In this case, the generation unit 115 avoids generating message information.

When the framer unit 160 accommodates the local packet, the transmit and receive unit 140 converts the OTN frame that has passed through the second input/output unit 114 into an optical signal (step S5), and transmits the optical signal (step S6). When the optical signal is transmitted, the optical transmission device 100 ends the process at the time of transmission. As a result, an optical signal is transmitted from the optical transmission device 100, and the optical transmission device 200 receives this optical signal.

On the other hand, in the process of step S3, when the flag data is the first flag data (step S3: YES), the generation unit 115 generates message information (step S7). That is, the generation unit 115 generates the first message information M1, the second message information M2, or the like described above. When the message information is generated, the drive unit 190 notifies of a write command of the write target data (step S8), and the process is terminated. More specifically, the drive unit 190 notifies the memory control unit 16A of the memory device 16 of the write command, and ends the processing. This allows the optical transmission device 100 to write the write target data in the memory device 16 supporting the NVMe at a high speed even when CXL packet is input.

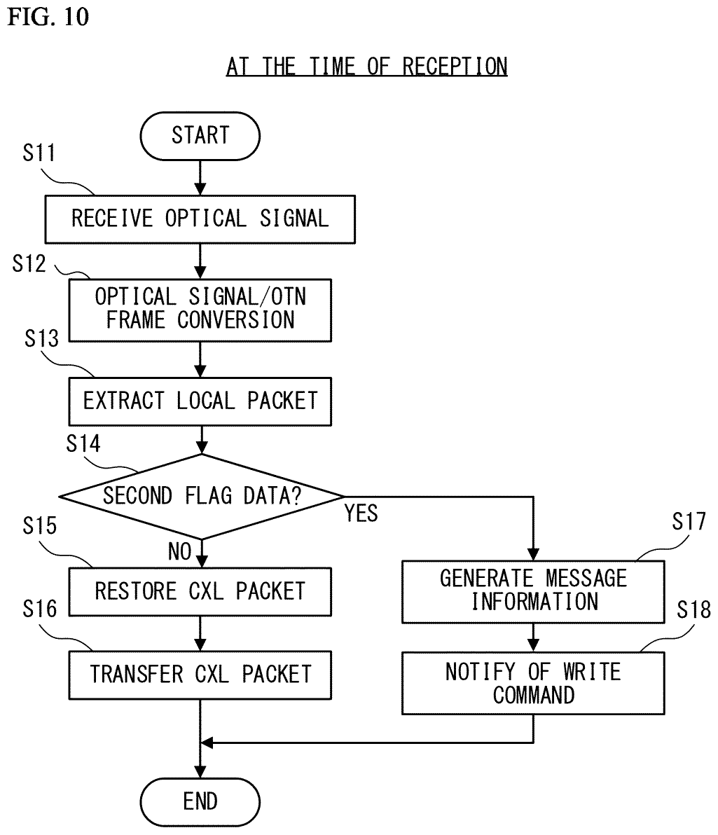

Next, the operation of the optical transmission device 200 at the time of reception will be described with reference to FIG. 10.

First, the transmit and receive unit (not illustrated) of the optical transmission device 200 receives an optical signal transmitted from the optical transmission device 100 (step S11). When the transmit and receive unit of the optical transmission device 200 receives the optical signal, it converts the optical signal into an OTN frame (step S12). When the transmit and receive unit of the optical transmission device 200 converts the optical signal into the OTN frame, the deframer unit 270 extracts the local packet from the OTN frame that has passed through the second input/output unit 214 (step S13). In the local packet extracted by the deframer unit 270, a part of the message data is excluded from the extraction target. Therefore, in the subsequent processing, the process of restoring the local packet extracted by the deframer unit 270 to the original CXL packet is required.

When the deframer unit 270 extracts the local packet, the second determination unit 280 determines whether the flag data is the second flag data (step S14). That is, the second determination unit 280 checks the message data of the local packet and determines whether the second flag data is included in the message data. When the flag data is not the second flag data (step S14: NO), the restoration unit 281 restores the CXL packet (step S15). For example, when the flag data is third flag data different from both the first flag data and the second flag data, the restoration unit 281 restores the original CXL packet from the local packet.

When the restoration unit 281 restores the CXL packet, the restoration unit 281 transfers the CXL packet (step S16), and ends the processing. More specifically, the restoration unit 281 transmits the CXL packet to the CXL device 20. In this manner, the CXL device 20 receives the CXL packet of the client signal transmitted from the server 10.

On the other hand, in the process of step S14, when the flag data is the second flag data (step S14: YES), the generation unit 215 generates message information (step S17). When the message information is generated, the drive unit 290 notifies of the write command of the write target data (step S18), and the process is terminated. This allows the optical transmission device 200 to write the write target data in the memory device 26 supporting the NVMe at high speed even when the write target data is the CXL packet of the client signal transmitted from the server 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A memory drive device comprising:
a memory; and
a processor coupled to the memory and configured to:
when receiving a specific packet according to a connection standard specified by Computer eXpress Link (CXL), store data included as a part of the specific packet in a buffer and determine whether addresses included as the part of the specific packet together with the data are consecutive,
when the addresses are consecutive, generate first information in which information of the addresses that are consecutive and information of the data associated with the addresses that are consecutive are aggregated, and
notify a memory device of a write request of the data to the memory device, based on the first information and the communication standard when the data stored in the buffer is written to the memory device specified by a communication standard that does not support the CXL.

2. The memory drive device according to claim 1, wherein the processor is further configured to:
when the addresses are not consecutive, generate second information in which information of a single non-consecutive address of the addresses and information of the data associated with the single non-consecutive address are aggregated, and
notify the memory device of the write request of the data to the memory device based on the second information and the communication standard.

3. The memory drive device according to claim 1, the processor is further configured to:
determine whether the specific packet is to be accommodated in a transmission frame for optical transmission based on flag information included in the specific packet, and
generate the first information when it is determined that the specific packet is not to be accommodated in the transmission frame.

4. The memory drive device according to claim 1, the processor is further configured to:
determine whether the specific packet is to be accommodated in a transmission frame for optical transmission based on flag information included in the specific packet, and
avoid generation of the first information when it is determined that the specific packet is to be accommodated in the transmission frame.

5. The memory drive device according to claim 1, wherein the communication standard is Non-Volatile Memory express (NVMe).

6. The memory drive device according to claim 5, wherein the memory device is an external storage device including a solid state drive (SSD), the external storage device supporting the NVMe.

7. An optical transmission system comprising:
a first optical transmission device configured to transmit a transmission frame for optical transmission to an optical transmission line, the transmission frame accommodating a specific packet; and
a second optical transmission device that includes the memory drive device according to claim 1 and is configured to receive the transmission frame from the optical transmission line,
wherein the processor receives the specific packet by the second optical transmission device extracting the specific packet from the transmission frame.

8. A memory drive method comprising:
when receiving a specific packet according to a connection standard specified by Computer eXpress Link (CXL), storing data included as a part of the specific packet in a buffer and determining whether addresses included as the part of the specific packet together with the data are consecutive,
when the addresses are consecutive, generating first information in which information of the addresses that are consecutive and information of the data associated with the addresses that are consecutive are aggregated, and
notifying a memory device of a write request of the data to the memory device, based on the first information and the communication standard when the data stored in the buffer is written to the memory device specified by a communication standard that does not support the CXL.

9. The memory drive method according to claim 8, further comprising:
when the addressees are not consecutive, generating second information in which information of a single non-consecutive address of the addresses and information of the data associated with the single non-consecutive address are aggregated, and
notifying the memory device of the write request of the data to the memory device based on the second information and the communication standard.

10. The memory drive method according to claim 8, further comprising:
determining whether the specific packet is to be accommodated in a transmission frame for optical transmission based on flag information included in the specific packet, and
generating the first information when it is determined that the specific packet is not to be accommodated in the transmission frame.

11. The memory drive method according to claim 8, further comprising:
determining whether the specific packet is to be accommodated in a transmission frame for optical transmission based on flag information included in the specific packet, and
avoiding generation of the first information when it is determined that the specific packet is to be accommodated in the transmission frame.
